(19) United States
(12) Patent Application Publication
(10) Pub. No.: US 2024/0143902 A1
(43) Pub. Date: May 2, 2024

(54) SYSTEM AND METHOD FOR AUTOFILL OF WEBPAGE FIELDS

(71) Applicant: ROYAL BANK OF CANADA, Toronto (CA)

(72) Inventors: Kyra GRANT, Toronto (CA); Darren BAPTISTE, Toronto (CA); Emma Arthur HOLLAND, Belleville (CA); Henry James GASKIN, Toronto (CA)

(21) Appl. No.: 18/385,784

(22) Filed: Oct. 31, 2023

Related U.S. Application Data
(60) Provisional application No. 63/420,912, filed on Oct. 31, 2022.

(51) Int. Cl. G06F 40/174; G06F 40/143

(52) U.S. Cl. CPC G06F 40/174; G06F 40/143

(57) ABSTRACT

A system and method for performing autofill of fields in a web page are disclosed. The method may include: obtaining user data associated with a user device used to access one or more web pages from a web server; obtaining site data from data communication messages between the user device and the web server; determining, using a page classifier module, if a current web page from the one or more web pages includes at least one input field for autofill; when the current web page is determined to include at least one input field for autofill: using a field classifier module to identify one or more input fields for autofill from the at least one input field; generating, based on one or both of the user data and site data, one or more values for the one or more input fields; and performing an autofill of the one or more input fields with the one or more values.

### CROSS-REFERENCE TO RELATED APPLICATION

This application claims the benefit of and priority to U.S. provisional patent application No. 63/420,912 filed on Oct. 31, 2022. The entire contents of this document is herein incorporated by reference.

### FIELD

Embodiments of the present disclosure relate to autofill of web page fields using computer-generated values.

### INTRODUCTION

A challenge with electronic field autofill is that there is significant variability in how web pages or web objects are presented from different sources, such as different eCommerce vendors, different platforms, different financial payment processing systems, all of which may utilize different coding approaches and architectures.

It can be difficult to provide a scalable and robust solution for autofill of fields in a website, that operates sufficiently and effectively in different types of contextual situations encountered in practical real-world implementation.

### SUMMARY

Electronic field autofill is a useful feature to implement in web page/web flow orchestration, as among others, it reduces certain frictions faced by users visiting web pages or encountering various web objects on web interfaces, such as the need to enter redundant information into web object input elements, including for example input boxes, forms, radio button lists, among others. Accordingly, electronic field autofill can be implemented to make a customer's shopping journey on eCommerce website more pleasant and efficient, where a customer must traverse through a number of different web pages (or simply “pages” throughout the disclosure) relating to different selection, payment, and/or checkout flows, making the shopping experience faster, smoother and more robust relative to previous approaches (e.g., manual entry of user data).

However, in practical computer implementation, electronic field autofill yields non-trivial computational and technical challenges. Specifically, in relation to certain types of dynamically rendered and loaded web elements, such as the use of iframes, the dynamically rendered and loaded web elements include elements that are dynamically assigned random and/or different identifiers on load. For this reason, conventional approaches to autofill are unable to operate because they cannot readily identify the element to conduct operations against (e.g., selectors and identifier data values may be dynamically assigned). The implementation of these dynamically rendered and loaded web elements such as iframes can be as part of an intentional design for cybersecurity reasons, among others, nevertheless, such dynamic web elements yield technical challenges in respect of conducting autofill operations.

An improved approach is proposed which utilizes a watcher process to monitor changes in a DOM structure or other indicators of a website having a plurality of web pages, in order to conduct one or more rounds of autofill of one or more input fields in the website.

In operation, when a web server delivers one or more web pages to a user, the operation of an autofill engine within a system described herein can generate and automatically fill, without the user having to manually entering any information, predetermined (e.g., as generated by a machine learning engine 140) values for different input fields in different interactive display elements on a user interface through injecting values into the input fields by an injection engine of the system. The injected values may be implemented as part of content through content scripts, while background processes (e.g., background scripts) interoperate in accordance with proposed approaches herein, all of which are coordinated through a browser controller that can initiate a page classifier module, a field classifier module, and a watcher process.

This solves a technical problem that arises in respect of real-world practical applications, where as a user visits different websites, common user data and site data may be automatically carried from one session with a first web page or website to another session with a different web page or web site. An objective may be to provide a harmonized experience for the user where the system is able to automatically engage in data message flows to securely synchronize backend operation, providing a specific technical improvements over alternate approaches which are limited by the “walled garden” technical limitations imposed by the technical ecosystems in which the applications or web servers operate within.

In accordance with one aspect, there is provided a system for autofill of one or more input fields on a web page, the system may include: a processor; a non-transitory computer-readable media storing instructions that when executed by the processor, cause the system to: obtain a first data set representative of user data associated with a user device used to access one or more web pages from a web server; obtain a second data set representative of site data from data communication messages between the user device and the web server; determine, using a page classifier module, if a current web page from the one or more web pages includes at least one input field for autofill; when the current web page is determined to include at least one input field for autofill: use a field classifier module to identify one or more input fields for autofill from the at least one input field; generate, based on one or both of the user data and site data, one or more values for the one or more input fields; and perform an autofill of the one or more input fields with the one or more values.

In some embodiments, the instructions, when executed by the processor, cause the system to: initiate a watcher process to periodically or continuously monitor changes in the current web page; perform an initial autofill of the one or more input fields in the current web page; and upon detecting a change on the current web page, perform a second autofill of the one or more input fields in the current web page.

In some embodiments, performing an autofill of the one or more input fields with the one or more values comprises: simulating a user-agent; and injecting, into an instruction set for loading user interface (UI) elements on an user interface for the current web page, a value from the one or more values, the value generated based on at least one data set from the user data.

In some embodiments, simulating the user-agent comprises: simulating a sequence of Hypertext Markup Language (HTML) events configured to simulate actions of the user-agent.

In some embodiments, the sequence of HTML events are pre-determined based on a type of input field from the one or more input fields.

In some embodiments, the value comprises part of payment or delivery information.

In some embodiments, the instructions, when executed by the processor, cause the system to: initiate a listener when a dormant script associated with the current web page indicates that an iframe is loaded as part of the current web page; and upon detecting, by the listener, that the iframe loaded is related to a checkout or payment process, perform autofill of one or more payment fields in the iframe loaded.

In some embodiments, the watcher process is configured to monitor changes in a Document Object Model (DOM) associated with the current web page.

In some embodiments, the watcher process is configured to monitor changes in one or more selectors in the site data.

In some embodiments, the one or more one or more values used for autofill for the one or more input fields are generated using a machine learning module.

In accordance with another aspect, there is provided a computer-implemented method for autofill of one or more input fields on a web page, the method may include: obtaining a first data set representative of user data associated with a user device used to access one or more web pages from a web server; obtaining a second data set representative of site data from data communication messages between the user device and the web server; determining, using a page classifier module, if a current web page from the one or more web pages includes at least one input field for autofill; when the current web page is determined to include at least one input field for autofill: using a field classifier module to identify one or more input fields for autofill from the at least one input field; generating, based on one or both of the user data and site data, one or more values for the one or more input fields; and performing an autofill of the one or more input fields with the one or more values.

In some embodiments, the method includes: initiating a watcher process to periodically or continuously monitor changes in the current web page; performing an initial autofill of the one or more input fields in the current web page; and upon detecting a change on the current web page, performing a second autofill of the one or more input fields in the current web page.

In some embodiments, performing an autofill of the one or more input fields with the one or more values comprises: simulating a user-agent; and injecting, into an instruction set for loading user interface (UI) elements on an user interface for the current web page, a value from the one or more values, the value generated based on at least one data set from the user data.

In some embodiments, simulating the user-agent comprises: simulating a sequence of Hypertext Markup Language (HTML) events configured to simulate actions of the user-agent.

In some embodiments, the sequence of HTML events are pre-determined based on a type of input field from the one or more input fields.

In some embodiments, the method includes: initiating a listener when a dormant script associated with the current web page indicates that an iframe is loaded as part of the current web page; and upon detecting, by the listener, that the iframe loaded is related to a checkout or payment process, performing autofill of one or more payment fields in the iframe loaded.

In some embodiments, the watcher process is configured to monitor changes in a Document Object Model (DOM) associated with the current web page.

In some embodiments, the watcher process is configured to monitor changes in one or more selectors in the site data.

In some embodiments, the one or more one or more values used for autofill for the one or more input fields are generated using a machine learning module.

In accordance with yet another aspect, there is provided a non-transitory computer readable medium storing machine interpretable instructions, when executed by a processor, cause the processor to perform: obtaining a first data set representative of user data associated with a user device used to access one or more web pages from a web server; obtaining a second data set representative of site data from data communication messages between the user device and the web server; determining, using a page classifier module, if a current web page from the one or more web pages includes at least one input field for autofill; when the current web page is determined to include at least one input field for autofill: using a field classifier module to identify one or more input fields for autofill from the at least one input field; generating, based on one or both of the user data and site data, one or more values for the one or more input fields; and performing an autofill of the one or more input fields with the one or more values.

In accordance with one aspect, there is provided a system for autofill one or more input fields on a web page, the system including: a processor operating in conjunction with computer memory and non-transitory computer readable media operating as a data storage, the processor configured to: obtain one or more data sets representative of user data and site data from data communication messages between a user device and a website having one or more web pages; perform an initial autofill of one or more input fields in a web page from the one or more web pages; initiate a watcher process to periodically or continuously monitor changes in the one or more web pages; and upon detecting an iframe trigger on a web page, conduct a second autofill of one or more input fields in the web page.

In some embodiments, an autofill of a field in the web page comprises injecting, into an instruction set for loading user interface (UI) elements on an user interface for the web page, a value based on at least one data item from the user data.

In some embodiments, the value may be part of payment card information.

In some embodiments, the value may be one of: a name, a credit card number, an expiry date, a billing address, and a telephone number.

In some embodiments, the value may be part of delivery information.

In some embodiments, the value may be one of: a name, a shipping address, a telephone number, and an e-mail address.

In some embodiments, the watcher process is configured to monitor changes in the Document Object Model (DOM).

In some embodiments, the watcher process is configured to monitor changes in one or more selectors in the site data.

In some embodiments, the second autofill is only conducted when the initial autofill fails.

In some embodiments, the second autofill is conducted with an interval.

In some embodiments, one or more one or more values used for autofill for the one or more input fields are generated based on output from a machine learning algorithm.

In accordance with another aspect, there is provided a computer-implemented method for autofill one or more input fields on a web page, the method including the steps of: obtaining one or more data sets representative of user data and site data from data communication messages between a user device and a website having one or more web pages; performing an initial autofill of one or more input fields in a web page from the one or more web pages; initiating a watcher process to periodically or continuously monitor changes in the one or more web pages; and upon detecting an iframe trigger on a web page, conducting a second autofill of one or more input fields in the web page.

In some embodiments, an autofill of a field in the web page comprises injecting, into an instruction set for loading user interface (UI) elements on an user interface for the web page, a value based on at least one data item from the user data.

In some embodiments, the value may be part of payment card information.

In some embodiments, the value may be one of: a name, a credit card number, an expiry date, a billing address, and a telephone number.

In some embodiments, the value may be part of delivery information.

In some embodiments, the value may be part of a payment information.

In some embodiments, the value may be one of: a name, a credit card number, an expiry date, a billing address, and a telephone number.

In some embodiments, the value may be part of delivery information.

In some embodiments, the value may be one of: a name, a shipping address, a telephone number, and an e-mail address.

In some embodiments, the watcher process is configured to monitor changes in the Document Object Model (DOM).

In some embodiments, the watcher process is configured to monitor changes in one or more selectors in the site data.

In some embodiments, the second autofill is only conducted when the initial autofill fails.

In some embodiments, the second autofill is conducted with an interval.

In some embodiments, one or more one or more values used for autofill for the one or more input fields are generated based on output from a machine learning algorithm.

In accordance with yet another aspect, there is provided a non-transitory computer readable medium storing machine interpretable instructions, when executed by a processor, cause the processor to perform any of the above elaborated method.

### BRIEF DESCRIPTION OF THE DRAWINGS

In the figures, embodiments are illustrated by way of example. It is to be expressly understood that the description and figures are only for the purpose of illustration and as an aid to understanding.

Embodiments will now be described, by way of example only, with reference to the attached figures, wherein in the figures:

FIG. 1 is a block schematic diagram of an example system for performing autofill of one or more input fields in a web page of a website, according to some embodiments;

FIG. 2 is a schematic diagram showing an overlap between user data and site data on a web page, according to some embodiments;

FIG. 3 is an example web page including an iframe, according to some embodiments;

FIG. 4 is an example process performed by the system in FIG. 1 for performing autofill of one or more input fields in a web page of a website, according to some embodiments;

FIG. 5 is an example computer device that may be used to implement the system in FIG. 1 for performing autofill of one or more input fields in a web page of a website, according to some embodiments;

FIG. 6 is another example process performed by the system in FIG. 1 for performing autofill of one or more input fields in a web page, according to some embodiments;

FIG. 7 shows an example web browser with multiple web pages in communication with the system in FIG. 1, in accordance with some example embodiments; and

FIG. 8 shows an example web browser with a web page being autofilled by the system in FIG. 1, in accordance with some example embodiments.

### DETAILED DESCRIPTION

As disclosed herein, an improved system is provided to enhance user experience (and user values) through performing autofill of one or more input fields in a web page of a website, which may involve automatically filling fields associated with one or more user interface (UI) elements with one or more values; the autofill of values for the UI elements may be rendered during particular set points within a user's browsing and/or shopping experience on a particular website, such as, for example, during a payment flow.

A user's browsing session, from a computational perspective, may include a series of state transitions between different user interface interaction points. The user interface rendered on a user's browser may include a number of UI elements, which may be filled or modified by computational elements of the system through injection (and where appropriate, re-injection) into the instruction set or code for rendering said user interface.

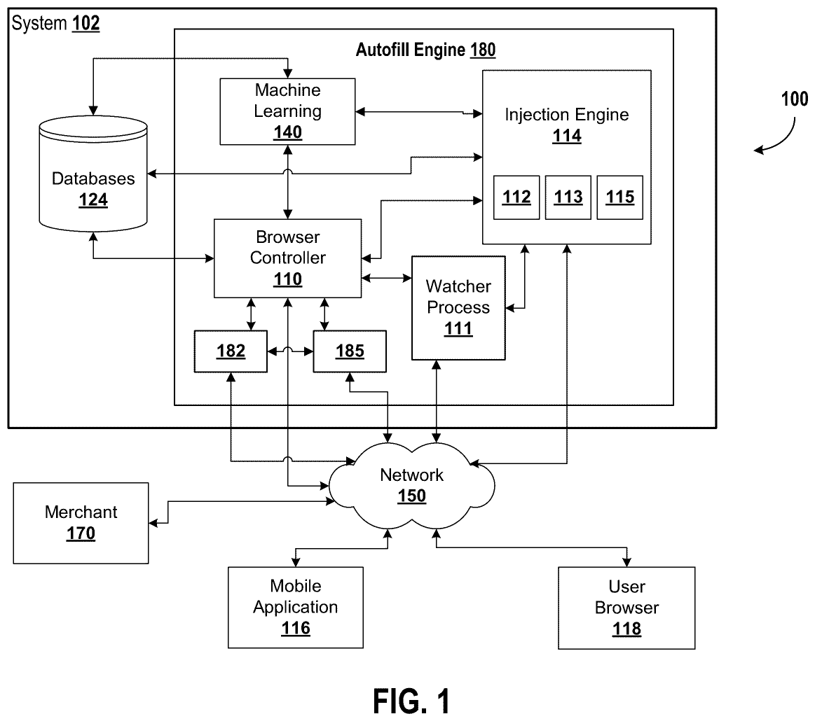

FIG. 1 is a block schematic diagram of an example architecture 100, which includes a system 102 for conducting autofill of one or more input fields in a web page, where the values for the one or more input fields may be generated based on user data or site data, or a combination of both, and may be further refined or generated based on output from a machine learning engine 140.

The system 102 includes a browser controller 110, a database 124 for storing user data and site data, a machine learning engine 140 for generating, when appropriate, predictive values for autofill of one or more input fields in a web page, and an injection engine 114 for generating commands for the autofill of the one or more input fields in a web page. The system 102 can be connected to one or more browsers 118 or mobile applications 116 through a network 150, such as a local area network, or a wide area network, such as an intranet, or the Internet.

The database 124 is configured for periodically or continuously storing user data (e.g., input data from a user device used to browse the web page) and site data (e.g., web data from the web page). For example, through the browser controller 110, one or more data objects from one or more data sets are obtained from the browser 118 or mobile application 116 in real time or near real time, and may be stored in the database 124. These data objects can be provided, for example, in the form of search queries, browsing navigation selections, user input relating to a payment card, billing information and delivery information, payment fulfillment, a shopping cart checkout, and so on.

In some embodiments, the browser controller 110 communicates with a page classifier module 182 to classify each web page and a field classifier module 185 to classify each field within the web page. The classification performed by the page classifier module 182 may be configured to determine if a web page, such as a current web page open in a user browser 118 or mobile application 116 contains at least one input field appropriate for autofill. The classification performed by the field classifier module 185 may be configured to determine if a field in the web page is an input field for autofill.

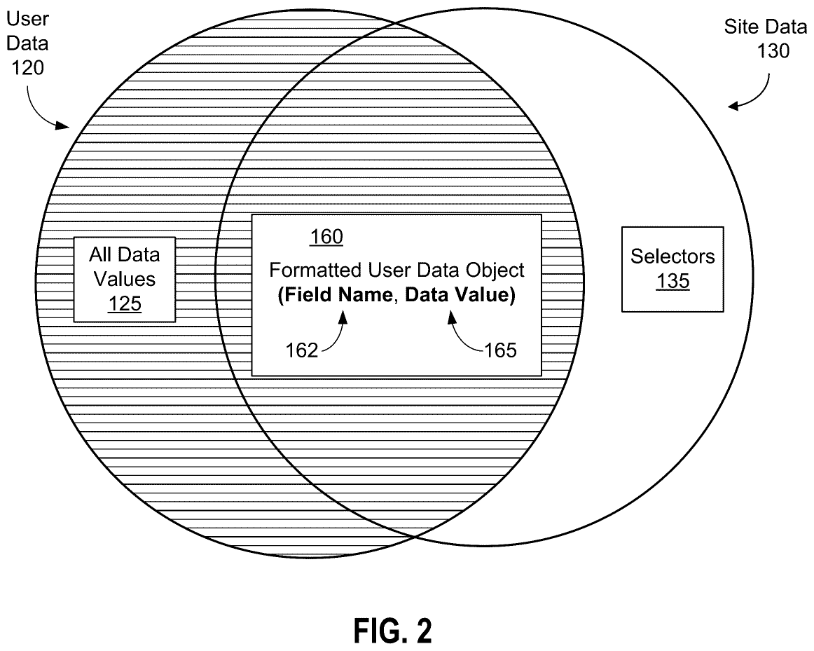

Referring now to FIG. 2, which shows a schematic diagram showing an overlap between user data 120 and site data 130 on a web page. Both the user data 120 and the site data 130 may need to be processed, such as through a series of formatting and modifications or additions, before they can be used to autofill one or more input fields. User data 120 may include data values 125. Site data 130 may be obtained via one or more selectors 135. A selector 135, such as a Cascading Style Sheets (CSS) selector, including for example a name selector, a type selector, a class selector, and an ID selector.

In some embodiments, for example, the name attribute from user data 120 may be used in combination with one or more selectors 135, such as one or more of the type selector, class selector, and ID selector, to determine a value of a missing attribute.

In some embodiments, for example, a name selector can identify and select a name attribute from site data 130, such as a name attribute from an input element in a Hypertext Markup Language (HTML) web page used to specify a name for the input element, may be used in combination with one or more selectors 135, such as one or more of the type selector, class selector, and ID selector, to determine a value of a missing attribute.

The type selector identifies an element based on its type, e.g., how that element is declared within HTML. The class selector identifies an element based on its class attribute value. The ID selector identifies an element based on its ID attribute value, which is unique and only used once per page.

A site data 130 may include a field name or field set name. A user data 120 may need to be processed into a data object 160 where the corresponding data value 165 is equivalent to the data value 125 of the user data 120, and the filed name 162 is a field name in the site data 130. In addition, the site data 130 may also be processed into an object that can be searched through.

In some embodiments, to start the autofill process of a field given by the site data 130, a selector of the field can be looked up using the query ‘document.queryselector( )’ and if the element is found, the element may be autofilled with the value 165 in user data 120 that corresponds to that field set name 162, which is the key in the formatted user data object 160.

A watcher process 111 can be initialized at the same time to watch for changes of the DOM. This is needed for example, when a checkout scenario has multiple buttons in the flow from shipping details, to a few more clicks needed to get to card details. The watcher process 111 continues until a checkout trigger or button, defined by site data, is clicked, after which the watcher process 111 disconnects and autofill ends.

In some embodiments, the database 124 is connected with one or more merchant ecosystem 170 to retrieve or obtain merchant data, if needed. For example, a merchant ecosystem 170 may be configured to store specific offers or promotions for a particular website. In these case, the database 124 may be using the merchant data to help autofill one or more input fields of in one or more web pages of the website.

In some embodiments, a browser controller 110 of system 102 may cause to install a front-end browser extension (not shown) that interoperates with an existing browser 118 to inject or otherwise modify rendering of information in one or more input fields in a web page rendered on the browser 118, or on a mobile application 116.

The system 102 may, in some embodiments, be configured to intercept web page (e.g., HTML, PHP) or mobile application information (e.g., JavaScript™ object notation or JSON data objects), and to inject (or re-inject if the initial inject fails) values to one or more user interface elements in the web page being browsed by the user, where a browser controller 110 acts to inject the values based on one or more signals from an injection engine 114, which may include an interpreter module 112, an iframe injection module 113 and a reinjection module 115.

The interpreter module 112, through browser controller 110, may cause a watcher process 111 or thread to be initiated and configured to monitor one or more changes on the web page, or a number of web pages in order to determine if any autofill attempt should be made.

The browser controller 110 can be configured to interface with different types of front-end clients, such as mobile applications 116 having an embedded user interface for shopping, an end-user browser 118 that may include native functionality and interface calls for interoperating with the system 102. For example, the browser controller 110 can generate electronic signals for autofill of predictive values at a user interface presented at the end user browser 118 through the provisioning of signals and control instructions to render the values.

The browser controller 110 can be configured to, in some embodiments, to intercept web page (e.g., HTML, PHP) or mobile application information (e.g., JavaScript™ object notation (JSON) data objects). The intercepted information can be obtained in different ways, such as using an HTTPS proxy for routing interaction information directly from the mobile application 116 or a browser 118, selectively transmitting information extracted by a browser extension, or through the use of an inspect element tool to allow the accessing of a source code of a web page or a merchant interface.

User input information or user data can also be tracked, such as specific clicks, keyboard entries, touch inputs, speech input, including those that relate to the navigation through or queries using the user interface.

The browser controller 110 (or the injection engine 114) can initiate and configure a watcher process 111, for each browsing session launched at browser 118 or mobile application 116, for a particular web page, track or monitor one or more features or elements of the web page or multiple web pages in a website. For example, the watcher process 111 may detect a change in a document object model (DOM) structure associated with the web page. For another example, the watcher process 111 may detect a change in one or more HTML codes used to render the user interface on the web page. For yet another example, the watcher process 111 may detect a change in dynamic elements such as a selector element on the web page. Each time any change or occurrence of a new data element is detected, the browser controller 110 can send a corresponding signal to the injection engine 114 notifying the change.

In some embodiments, the browser controller 110, through the watcher process 111, may generate a watcher instance, as part of injected content script, to read or interrogate a DOM structure associated with the web page, in order to determine if a change or modification has occurred within the web page.

The browser controller 110 may also detect an iframe within a web page, or within a DOM of a web page. For instance, the controller 110 may use the watcher process 111 to detect an iframe in a web page. In some embodiments, a listener instance may be generated by the watcher process 111 or the browser controller 110 to monitor an iframe trigger, which may be for example an iframe tag within a DOM structure of a web page. In some embodiments, iframe trigger or tag may be passed from the browser of a user device to a background script, and subsequently detected by the listener instance.

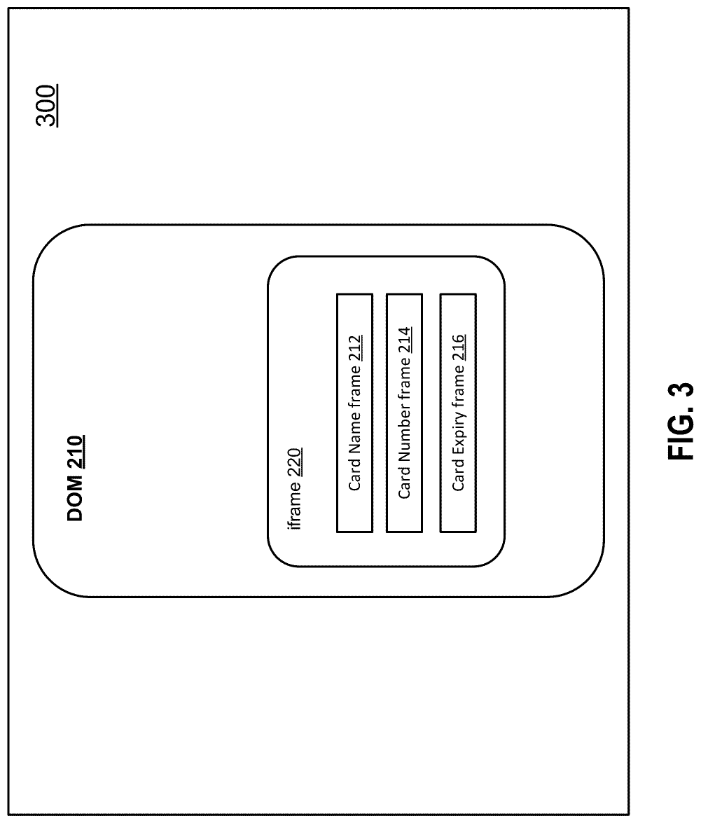

An iframe, or an inline frame, is a HTML element that loads a separate HTML page within a web page. Typically, an iframe is specified by a tag in the HTML code used to render the web page, such as an <iframe> tag. Referring now to FIG. 3, which illustrates an example website 300 implemented using DOM 210. DOM 210 may contain an iframe 220. The iframe 220 may include one or more input fields or frames, such as card name frame 212, a card number frame 214 and a card expiry frame 216.

In some embodiments, a checkout process on an eCommerce website may implement iframes as a secure container for receiving and containing payment details. An iframe is a html element that loads a separate html element inside of itself and is essentially like a barricaded island in the middle of the DOM. Inside the payment iframe 220, although there is still a card number, card expiry and card name, the selectors change on every page load and refresh. Therefore, the traditional method of autofill cannot work since the selector is changed at random. The system 102 is implemented to overcome this problem by implementing the browser controller 110 and the injection engine 114.

The injection engine 114 includes an interpreter module 112, which is configured to obtain, from browser 118, user data 120 and site data 130, including one or more values representing a payment information (e.g., payment card details). It is the starting point where autofill is attempted and configures whether a second round of autofill, iframe injection or reinjection is required. A watcher process 111 as described above may be initiated by interpreter module 112 to monitor any changes on the website to help with determination regarding subsequent attempts of autofill.

If there is an iframe trigger from the site data 130, such as the <iframe> tag, iframe injection module 113 is called upon to initiate a dormant script that is waiting in all frames and once signalled by the background script, will come alive and attempt autofill of one or more input fields in the iframe within a web page.

In some embodiments, the reinjection module 115 is needed in a checkout scenario with iframes, and when a next step button is needed to be clicked to continue entering shipping, billing and card information. When the browser controller 118 detects that a next step button during the checkout process is clicked by a user, a second or subsequent round of attempt of injection or autofill is performed by the reinjection module 115, so that after every user input (e.g., click) on the next step button, autofill can continue, injecting values into iframes for card details. The autofill process can end when the final checkout button “pay now” or similar is clicked by the user in the checkout process.

For example, the system 102 is able to successfully autofill shipping, billing and payment card details in a variety of checkout scenarios and into any iframe-supported checkout process.

The interpreter module 112 through the watcher process 111 can monitor for changes of the Document Object Model (DOM), and further cause, when appropriate, an iframe injection, or reinjection, and end once a final checkout button is clicked.

The browser controller 110 may, in some embodiments, identify the structure of a web page or a response message (e.g., through interrogating a DOM structure), and directly modify the rendered user interface through the identification of sections in the DOM structure, and further cause to modify, add, or transform one or more web elements or code snippets to perform autofill of values in one or more input fields of a web page rendered at browser 118 or mobile application 116. Throughout this disclosure, autofill of values on a web page may be referred to as “injection” or “reinjection”.

Collectively, the browser controller 110, watcher processor 111, injection engine 114, machine learning engine 140, page classifier module 182 and field classifier module 185 may be referred to as an autofill engine 180. The autofill engine 180 is responsible for determining if and when a web page requires autofill, and proceeds to perform the required autofill action, including for example, generation of predicted values for one or more fields within the web page and filling the fields with the generated predicted values.

In some embodiments, autofill of values may occur to fill text input elements (e.g., name, street address) only. In some embodiments, autofill of values may occur to fill text input elements as well as other types of elements, such as, for example, to select an option presented in a select element, which renders a plurality of options (e.g., select drop-down list created by HTML <select> tag). Select elements may be used for province and country, or for credit card expiry months and years. The browser controller 110 may identify the structure of a webpage or a response message (e.g., through reading or interrogating a DOM structure), and directly modify the rendered user interface through the identification of sections in the DOM structure, then further modify, add, or transform one or more web elements or code snippets to perform autofill of values in one or more fields of a webpage, including text input elements and select elements, in the rendered at browser 118 or mobile application 116. Other types of input elements may be autofilled as well, including for example, button element, checkbox element, date element, email element, radio element, range element, and so on.

During a checkout process which may span multiple checkout web pages, the system 102 can, through browser controller 110, collect web forms and data such as shipping address, contact information, and payment information (e.g., credit card details), and predicting, via the machine learning engine 140, respective label(s) of each of the input fields in a given form. For example, input fields with text types can be predicted with high accuracy.

In some embodiments, a dormant script, separate from all existing content and background scripts, may be initialized by the injection engine 114. The dormant script has a manifest file, which has the value of “all_frames” set to true. By this set up, the dormant script is configured to wait in each frame and can successfully autofill in one or more input fields, such as card name frame 212, a card number frame 214 and a card expiry frame 216.

To start the script, the injection engine 114 first makes a browser send a message to the background script, which in turn sends another message “iframeInject”. The dormant script has a listener for the “iframeInject” call, and only after the page and all frames have loaded, will cause the iframe injection module 113 to start iframe injection, e.g., autofill one or more input fields in the web page. In some embodiments, the iframe injection or autofill may be implemented with an interval to try obtaining the web element and then perform autofill of the input field with an appropriate value. This interval is set to a period above a minimum threshold (e.g., 1000 ms) so that the iframe does not recognize the autofill action or block the autofill process. After the interval is up, the iframe injection process ends.

In some embodiments, the watcher process 111 or the browser controller 110 may be configured to determine if a web page contains an iframe page. For instance, content or dormant script can be configured to pass a message to background script if and when an iframe is loaded or running within a current web page, and the background script may communicate with the autofill engine 108 of system 102 over the network 150 to relay that an iframe page is loaded. The content script may include, for instance, the watcher process 111 to look for an iframe tag within the HTML elements of a DOM structure of the web page. When an iframe tag is located by the watcher process 111, the content or dormant script may send a message to the background script indicating the same, which means that an iframe page has been loaded within the current web page.

Once it is determined that an iframe page has loaded within a current web page, a listener instance may be initiated for the iframeInject call and continue with injection, as configured by the injection engine 114. In this manner, the iframeInject call is only launched after the iframe with the dormant script has been initialized, which eliminates or reduces errors with injection/mistiming.

In some embodiments, the dormant script may be in every iframe, but the listener is only initialized for the IframeInject call in payment frames that have been identified corresponding to the payment fields requiring autofill. In this manner, generation of values and autofilling of input fields in iframes are only performed when the iframe is identified (e.g., by the page classifier module 182) to include at least one field requiring autofill. For instance, the iframe page may be part of a checkout process, which may require autofill of payment card information. And when the iframe page is unrelated to autofill, such as a Google™ analytics frame, the autofill of values will not be triggered, and a timing interval is not required.

The reinjection module 115 in the injection engine 114 is a third component for an autofill process. Typically, in websites using iframes spanning multiple web pages, the checkout process is separated into multiple pages, a “next” button is placed at each page to proceed to the next check out page, and a final checkout button is at the second last web page before payment card is taken for processing.

A final checkout button typically indicates that the checkout process is reaching a final stage, that is, all payment, billing and shipping information has been received and autofilled where appropriate. Therefore, during a typical autofill process, the watcher process 111 may be configured to use a query (e.g., jQuery #id selector) to look for an ID attribute of an HTML tag to find the specific element corresponding to the final checkout button.

In some embodiments, the watcher process 111 may be configured to use a JavaScript™ document.querySelector or .querySelectorAll, which are Document methods, to look for an ID attribute of an HTML tag to find the specific element corresponding to the final checkout button.

In some embodiments, the browser controller 110 communicates with a page classifier module 182 to classify each web page and a field classifier module 185 to classify each field within the web page. The classification performed by the page classifier module 182 may be configured to determine if a web page, such as a current web page open in a user browser 118 or mobile application 116 contains at least one input field appropriate for autofill. The classification performed by the field classifier module 185 may be configured to determine if a field in the web page is an input field for autofill.

In some embodiments, a page classifier module 182 may be initiated and monitored by browser controller 110 to read and analyze information on a web page, in order to determine if the web page includes at least one input field for autofill. For instance, the page classifier module 182 may be configured to analyze the html elements such as html tags and text to determine if the web page is a part of a checkout process, including a payment page.

For instance, a page classifier module 182 can include can include a module implemented based on Term Frequency-Inverse Document Frequency (TFIDF) used to determine relevancy of the web page as it relates to one or more topics or search terms. The page classifier module 182 is configured to perform text mining based on TFIDF by analyzing, for each web page, all elements including tags, text data, and other information in order to determine one or more keywords and their associated respective frequency and respective weights, the keywords or terms with higher weight scores are considered to be more relevant or important. Using this method, the page classifier module 182 can determine a current web page is most likely part of a checkout process, or more specifically, a payment process including an input field for payment information, when the relevant TFIDF score is above a predetermined threshold.

A field classifier module 185 can be initiated by browser controller 110 when a page classifier module 182 has determined that a web page includes at least one input field requiring autofill. The field classifier module 185 can be configured to classify each input field on the web page as whether it is an appropriate input field for autofill, and if so, the type of input required (e.g., delivery address or payment card). The classification by field classifier module 185 may be performed by a machine learning model, such as machine learning model 140, which may include trained machine learning models for text mining and text analysis, such as, for example, machine learning models implemented based on gradient-boosting (e.g., using XGBoost Algorithm).

Injection process performed by the injection model 114 can occur after the page classifier module 182 has determined that a current web page has at least one input field needing autofill, and the field classifier module 185 has determined the exact input fields for autofill of one or more values. For instance, if a current web page is the start of a checkout or payment process, and after a user consent has been obtained, the machine learning model 140 may be executed to generate one or more predicted values for one or more input fields within the current web page, and the injection model 114 may be launched by the browser controller 110 to start injection process.

In some embodiments, in websites using iframes spanning multiple web pages, the checkout process is separated into multiple pages, a “next” button (for proceeding to the next page of checkout process) may appear to be the same type as the final checkout button, i.e., having the same ID attribute/HTML tag, or corresponding to the same ID selector.

This means that in a typical autofill process, an autofill or injection process may be configured to end after receiving indication that the final checkout button is clicked, which means a typical or first autofill action may in fact end after a first set of user data (e.g., shipping information) has been entered, but remaining information is still missing when the user clicks on the “next” button. The injection engine 114 can, in these cases, check in the browser's local storage process to determine, when appropriate, whether iframe injection or reinjection should proceed, as described below.

For example, during a multi-page checkout. The reinjection module 115 is configured to send out a message “reinject” to a background script, where the background script then stores the key-value pair “autoInject, reinject” into the browser's local storage. In addition, the reinjection module 115 listens for that call and checks if that key-value pair exists in local storage. If “autoInject, reinject” key-value pair exists, a ‘browser.webNavigation.onCompleted.addListener( )’ is added. Once it is loaded, it triggers to run a reinject handler to gather the user data 120, site data 130 and payment card information again, and re-initialize the interpreter module 112. This restarts the cycle of trying to autofill, retrying the autofill process if it's a new page, and finally at the end with the payment details, starting the iframe injection process.

After multiple rounds of checking and starting the iframe injection process, and once the checkout button is clicked, an end-inject command may clear the browsers local storage specifically of that key-pair and the autofill cycle has ended.

In some embodiments, checkout web pages are type of web forms with wide variety in field names, position of the fields and its attributes. Machine learning techniques implemented in the machine learning engine 140 can be used to automatically fill out checkout forms by learning the patterns in the form fields and their order, which can provide more scalable and robust autofill of one or more input fields on a web page during the checkout process.

Machine learning engine 140 may be, in some embodiments, configured to receive at least one of user data and site data and generate predictive values for autofill of one or more input fields in a web page. In some embodiments, the machine learning engine 140 may include transformer based machine learning models for performing value prediction. In some embodiments, machine learning engine 140 may be configured to generate a determination if an iframe exists within a given web page.

The machine learning engine 140 can be optimized, through supervised training using prior tracked results, or reinforcement learning using real-world results, to generate predictive values for autofill of one or more input fields in a web page based on the at least one of user data and site data.

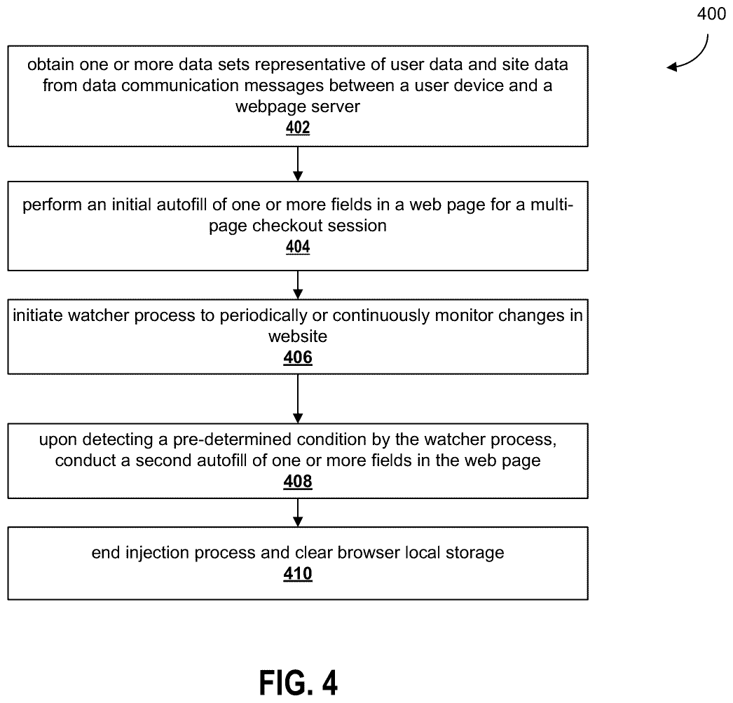

FIG. 4 is an example process 400 performed by the system in FIG. 1 for performing autofill of one or more input fields in a web page of a website, according to some embodiments. At operation 402, the system 102 obtains one or more data sets representative of user data 120 and site data 130 from data communication messages between a user device and a web page server.

At operation 404, the system 102 performs an initial autofill (“injection”) of one or more input fields in a web page for a multi-page checkout session. This may be performed, for example, by an injection engine 114, such as iframe injection module 112 of the injection engine 114.

In some embodiments, an autofill of a field in the web page comprises injecting, into an instruction set for loading user interface (UI) elements on an user interface for the web page, a value based on at least one data item from the user data 120.

In some embodiments, the value may be part of payment card information.

In some embodiments, the value may be one of: a name, a credit card number, an expiry date, a billing address, and a telephone number.

In some embodiments, the value may be part of delivery information.

In some embodiments, the value may be one of: a name, a shipping address, a telephone number, and an e-mail address.

At operation 406, which may happen at the same time as operation 404, a watcher process 111 is initiated by the system 102, such as by the interpreter module 112 of injection engine 114, to periodically or continuously monitor changes in website (e.g., DOM tree, separate HTML elements, selectors in site data 130).

In some embodiments, the watcher process 111 is configured to monitor changes in the Document Object Model (DOM).

In some embodiments, the watcher process 111 is configured to monitor changes in one or more selectors in the site data.

The watcher process 111 monitors site data to identify iframe triggers (e.g., such as the <iframe> tag), to prepare for a checkout scenario with one or more next step or “next” buttons.

At operation 408, upon detecting a pre-determined condition by the watcher process 111, a component of the system 102, such as the reinjection module 115, may conduct re-injection or second round of autofill action. In some embodiments, the second round of autofill action may be performed with a delay of an interval (e.g., 1000 ms).

In some embodiments, an example pre-determined condition may be, for example, an iframe trigger detected by a listener (e.g., event listener), a modal appearing, or an additional new input field relating to a checkout process that has not yet been processed.

In some embodiments, the second autofill is only conducted when the initial autofill fails.

In some embodiments, one or more one or more values used for autofill for the one or more input fields are using a machine learning model executing a trained machine learning algorithm. Such a machine learning model may be implemented by way of machine learning engine 140, for example.

Machine learning engine 140 may be, in some embodiments, configured to receive at least one of user data and site data and generate predictive values for autofill of one or more input fields in a web page. In some embodiments, machine learning engine 140 may be configured to generate a determination if an iframe exists within a given web page.

The machine learning engine 140 can be optimized, through supervised training using prior tracked results, or reinforcement learning using real-world results, to generate predictive values for autofill of one or more input fields in a web page based on the at least one of user data and site data.

At operation 410, the system 102 can end injection or autofill process and clear browser local storage.

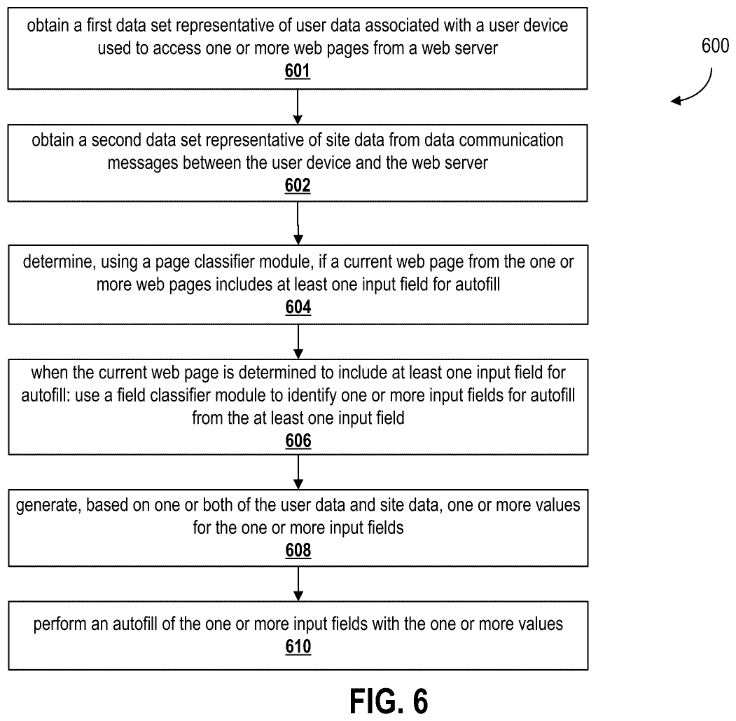

FIG. 6 shows another example process 600 performed by the system in FIG. 1 for performing autofill of one or more input fields in a web page, according to some embodiments.

At operation 601, the system 102 obtains a first data set representative of user data associated with a user device used to access one or more web pages from a web server.

At operation 602, the system 102 obtains a second data set representative of site data from data communication messages between the user device and the web server.

At operation 604, the system 102 determines, using a page classifier module 182, if a current web page from the one or more web pages includes at least one input field for autofill.

In some embodiments, the browser controller 110 communicates with a page classifier module 182 to classify each web page and a field classifier module 185 to classify each field within the web page. The classification performed by the page classifier module 182 may be configured to determine if a web page, such as a current web page open in a user browser 118 or mobile application 116 contains at least one input field appropriate for autofill. The classification performed by the field classifier module 185 may be configured to determine if a field in the web page is an input field for autofill.

In some embodiments, a page classifier module 182 may be initiated and monitored by browser controller 110 to read and analyze information on a web page, in order to determine if the web page includes at least one input field for autofill. For instance, the page classifier module 182 may be configured to analyze the html elements such as html tags and text to determine if the web page is a part of a checkout process, including a payment page.

For instance, a page classifier module 182 can include can include a module implemented based on Term Frequency-Inverse Document Frequency (TFIDF) used to determine relevancy of the web page as it relates to one or more topics or search terms. The page classifier module 182 is configured to perform text mining based on TFIDF by analyzing, for each web page, all elements including tags, text data, and other information in order to determine one or more keywords and their associated respective frequency and respective weights, the keywords or terms with higher weight scores are considered to be more relevant or important. Using this method, the page classifier module 182 can determine a current web page is most likely part of a checkout process, or more specifically, a payment process including an input field for payment information, when the relevant TFIDF score is above a predetermined threshold.

At operation 606, when the current web page is determined to include at least one input field for autofill: the system 102 uses a field classifier module 185 to identify one or more input fields for autofill from the at least one input field.

A field classifier module 185 can be initiated by browser controller 110 when a page classifier module 182 has determined that a web page includes at least one input field requiring autofill. The field classifier module 185 can be configured to classify each input field on the web page as whether it is an appropriate input field for autofill, and if so, the type of input required (e.g., delivery address or payment card). The classification by field classifier module 185 may be performed by a machine learning model, such as machine learning model 140, which may include trained machine learning models for text mining and text analysis, such as, for example, machine learning models implemented based on gradient-boosting (e.g., using XGBoost Algorithm).

At operation 608, the system 102 generates, based on one or both of the user data and site data, one or more values for the one or more input fields.

At operation 610, the system 102 performs an autofill of the one or more input fields with the one or more values.

Injection process performed by the injection model 114 can occur after the page classifier module 182 has determined that a current web page has at least one input field needing autofill, and the field classifier module 185 has determined the exact input fields for autofill of one or more values.

In some embodiments, the system 102 initiates a watcher process 111 (e.g., via browser controller 110) to periodically or continuously monitor changes in the current web page, performs an initial autofill of the one or more input fields in the current web page; and upon detecting a change on the current web page, performs a second autofill of the one or more input fields in the current web page.

Upon detecting a pre-determined condition by the watcher process 111, a component of the system 102, such as the reinjection module 115, may conduct re-injection or second round of autofill action.

In some embodiments, the system 102 launches the watcher process 111 when the page classifier module 182 has determined that the current web page includes at least one input field for autofill. For instance, the page classifier module 182 may determine that the current web page is part of a checkout process or payment process, and therefore includes at least one field for autofill.

In some embodiments, the system 102 initiates the watcher process 111 at the same time as it initiatives the page classification module 182.

In some embodiments, the watcher process 111 is configured to monitor changes in a Document Object Model (DOM) associated with the current web page. In some embodiments, the watcher process 111 is configured to monitor changes in one or more selectors in the site data.

As mentioned, the watcher process 111 is used to detect new changes or modifications to the same web page, and whenever a change or modification is detected in the web page, a field classifier module 185 is launched again to determine one or more input fields for autofill in the web page.

In some embodiments, an example pre-determined condition may be, for example, an iframe trigger detected by a listener (e.g., event listener), a modal appearing, or an additional new input field relating to a checkout process that has not yet been processed.

In some embodiments, performing an autofill of the one or more input fields with the one or more values includes: simulating a user-agent; and injecting, into an instruction set for loading user interface (UI) elements on an user interface for the current web page, a value from the one or more values, the value generated based on at least one data set from the user data.

Based on a structure or architecture of the current web page and in order to correctly set the value of an input field, a unique combination of HTML events need to occur, or detected by the server as having been caused by a user-agent. This ensures that the HTML element accepts the change in value and any UI that changes associated with it occurs (such as hoisting of labels).

One implementation to simulate a user-agent is to set the values of all elements and ensure that it is accepted with a unique sequence of these events that in the right order simulate a user-agent to the best of its abilities. Through the simulation and sequence of click, focus, input, change, blur, focusout and mouseout, the HTML element accepts the change or update of value, and the injection process by the injection engine 114 can be successful.

In some embodiments, simulating the user-agent includes: simulating a sequence of Hypertext Markup Language (HTML) events configured to simulate actions of the user-agent.

In some embodiments, an example user-agent simulation may include ID, name, combination of input to simulate the user-agent, which may be a software that retrieves, renders and facilitates end user interaction with Web content, or whose user interface is implemented using Web technologies.

In some embodiments, a user-agent can be a web browser used to communicate with a web server to identify itself and provide information about the browser's capabilities. The user-agent string can include information such as the browser type and version, the operating system, and the device type.

In some embodiments, a listener is launched within a content or dormant script of the web page to detect an iframe trigger, in parallel to the page classifier module 182 being running to classify a given web page. The content or dormant page can listen to an occurrence of an iframe element or tag, and passes this information to background scrip that talks to the autofill engine 118 of system 102.

In some embodiments, the sequence of HTML events are pre-determined based on a type of input field from the one or more input fields.

For example, for a given type of input field, the sequence of HTML events may include, in the following order: touchstart, click, touchend, focus, focusin, input, change, blur, focusout, and mouseout.

The HTML events may be simulated by the following string:
var changeEvent=new Event(‘change’, {bubbles: true, cancelable: false});
element.dispatchEvent(changeEvent).

In some embodiments, the system 102 can initiate a listener when a dormant script associated with the current web page indicates that an iframe is loaded as part of the current web page; and upon detecting, by the listener, that the iframe loaded is related to a checkout or payment process, perform autofill of one or more payment fields in the iframe loaded.

In some embodiments, the one or more one or more values used for autofill for the one or more input fields are generated using a machine learning module 140.

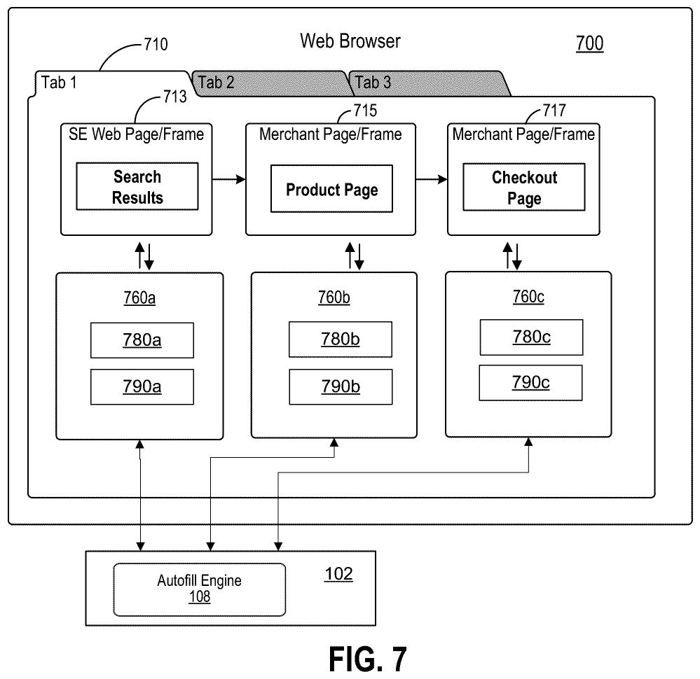

FIG. 7 shows an example web browser with multiple web pages in communication with an autofill engine 108 of system 102, in accordance with some example embodiments. A browser 700 may have multiple tabs 710 open, and one active tab 710 may visit multiple webpages 713, 715, 717 in a sequential order. For example, search results may be displayed at a first webpage 713, then a product page 715 may be launched upon being clicked or tapped by user, the user may then proceed to a checkout page 717. Throughout the whole process, multiple groups of content scripts 780a, 780b, 780c and background scripts 790a, 790b, 790c may actively listen at each web page. A pair 760a, 760b, 760c of content script and background script may also be implemented in the form of a browser extension. At least all of the background scripts 790a, 790b, 790c are in communication with the autofill engine 108 of system 102 in order to determine if any given web page is appropriate for or requires autofill.

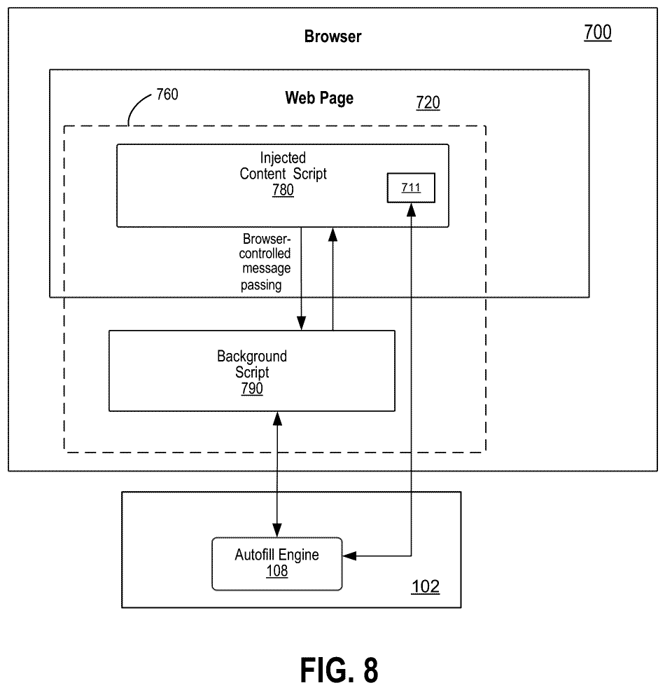

FIG. 8 shows an example web browser 700 with a web page 720 being autofilled by an autofill engine 108 of system 102, in accordance with some example embodiments. In a pair 760 of injected content script 780 (e.g., JavaScript™ files) and background script 790, code containing the content script run in the context of web pages and can modify the content of a page or interact with the page's Document Object Model (DOM). For example, autofill engine 108 can cause (e.g., via injection engine 114) to inject content script 780, which can communicate with a corresponding background script 790 via browser-controlled message passing. Scripts and data in this tier share a common browser context, accessible by the host domain (e.g. Merchant or Payment Service Provider). The injected content script 780 may include, for example, a watcher instance 711 initiated by the watcher process 111.

### Application of Autofill of Input Fields in Web Pages

In a health information system, patients health information, including health card information, diagnosis reports, medical history, allergy reactions, vaccinations, treatment information plans, test results, and so on, are collected, stored and managed. A patient may visit different websites or mobile applications, each directed to a different health care entity: a medical professional, a hospital, and a pharmacy, in order to receive one or more treatments or one or more diagnosis. All of these different health care entities may each has a different information technology system in place, or require an online user to login and provide identifying information (e.g., insurance information or health card number), prior to allowing the user access to healthcare services or drugs. With the autofill engine 108 and the system 102 discussed herein, computational efficiencies can be achieved, and computational resources saved, when at least a certain set of user data (e.g., name, address, insurance information, health card number) are autofilled across all health care entities and their respective websites.

In addition, medical reports may be autofilled when the user has given explicit permission and consent for using said medical reports by the autofill engine 108. For instance, a psychologist report from a psychologist stored in the health information system for patient Sarah D. may include input fields requiring one or more values or statements from stored doctor notes from a family physician for the same patient, and the autofill engine 108 and the system 102 may retrieve the doctor notes as user data, reviewing the psychologist report to identify one or more input fields for autofill, generate the appropriate values for the one or more fields based on the doctor notes, and perform autofill using injection engine 114, in accordance with the embodiments described herein.

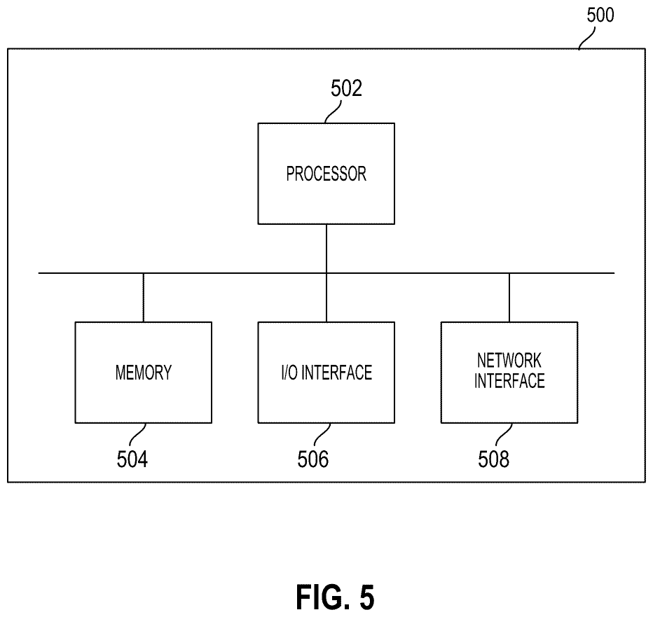

FIG. 5 is a schematic diagram of an example computer device 500 that may be used to implement the system 102 in FIG. 1 for performing autofill of one or more input fields in a web page of a website, according to some embodiments. As depicted, computing device 500 includes one or more processors 502, memory 504, one or more I/O interfaces 506, and one or more network interfaces 508.

When computing device 600 is part of the system 102, for example, at least the autofill engine 108 transforms the system 102 into a special purpose machine that is capable of performing autofill in one or more input fields within one or more web pages to deliver a seamless user experience. For instance, the look and feel of a website or web page rendered by the browser 700 are based in part on content script injected by the autofill engine 108, which are managed by the components of autofill engine 108 and system 102 as described herein.

Each processor 502 may be, for example, a microprocessor or a microcontroller, a digital signal processing (DSP) processor, an integrated circuit, a field programmable gate array (FPGA), a reconfigurable processor, a programmable read-only memory (PROM).

Memory 504 may include a suitable combination of computer memory that is located either internally or externally such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like. Memory 504 may store code executable at processor 502, which causes system 102 to function in manners disclosed herein. Memory 504 includes a data storage. In at least some embodiments, the data storage includes a secure datastore. In at least some embodiments, the data storage stores received data sets, such as textual data, image data, or other types of data.

Each I/O interface 506 enables computing device 500 to interconnect with one or more input devices, such as a keyboard, mouse, camera, touch screen and a microphone, or with one or more output devices such as a display screen and a speaker.

Each network interface 508 enables computing device 500 to communicate with other components, to exchange data with other components, to access and connect to network resources, to serve applications, and perform other computing applications by connecting to a network such as network (or multiple networks) capable of carrying data including the Internet, Ethernet, plain old telephone service (POTS) line, public switch telephone network (PSTN), integrated services digital network (ISDN), digital subscriber line (DSL), coaxial cable, fiber optics, satellite, mobile, wireless (e.g. Wi-Fi, WiMAX), SS7 signaling network, fixed line, local area network, wide area network, and others, including any combination of these.

The embodiments of the devices, systems and methods described herein may be implemented in a combination of both hardware and software. These embodiments may be implemented on programmable computers, each computer including at least one processor, a data storage system (including volatile memory or non-volatile memory or other data storage elements or a combination thereof), and at least one communication interface.

Program code is applied to input data to perform the functions described herein and to generate output information. The output information is applied to one or more output devices. In some embodiments, the communication interface may be a network communication interface. In embodiments in which elements may be combined, the communication interface may be a software communication interface, such as those for inter-process communication. In still other embodiments, there may be a combination of communication interfaces implemented as hardware, software, and combination thereof.

Throughout the foregoing discussion, numerous references will be made regarding servers, services, interfaces, portals, platforms, or other systems formed from computing devices. It should be appreciated that the use of such terms is deemed to represent one or more computing devices having at least one processor configured to execute software instructions stored on a computer readable tangible, non-transitory medium. For example, a server can include one or more computers operating as a web server, database server, or other type of computer server in a manner to fulfill described roles, responsibilities, or functions.

The foregoing discussion provides many example embodiments. Although each embodiment represents a single combination of inventive elements, other examples may include all possible combinations of the disclosed elements. Thus if one embodiment comprises elements A, B, and C, and a second embodiment comprises elements B and D, other remaining combinations of A, B, C, or D, may also be used.

The term “connected” or “coupled to” may include both direct coupling (in which two elements that are coupled to each other contact each other) and indirect coupling (in which at least one additional element is located between the two elements).

The technical solution of embodiments may be in the form of a software product. The software product may be stored in a non-volatile or non-transitory storage medium, which can be a compact disk read-only memory (CD-ROM), a USB flash disk, or a removable hard disk. The software product includes a number of instructions that enable a computer device (personal computer, server, or network device) to execute the methods provided by the embodiments.

The embodiments described herein are implemented by physical computer hardware, including computing devices, servers, receivers, transmitters, processors, memory, displays, and networks. The embodiments described herein provide useful physical machines and particularly configured computer hardware arrangements. The embodiments described herein are directed to electronic machines and methods implemented by electronic machines adapted for processing and transforming electromagnetic signals which represent various types of information. The embodiments described herein pervasively and integrally relate to machines, and their uses; and the embodiments described herein have no meaning or practical applicability outside their use with computer hardware, machines, and various hardware components. Substituting the physical hardware particularly configured to implement various acts for non-physical hardware, using mental steps for example, may substantially affect the way the embodiments work. Such computer hardware limitations are clearly essential elements of the embodiments described herein, and they cannot be omitted or substituted for mental means without having a material effect on the operation and structure of the embodiments described herein. The computer hardware is essential to implement the various embodiments described herein and is not merely used to perform steps expeditiously and in an efficient manner.

The embodiments and examples described herein are illustrative and non-limiting. Practical implementation of the features may incorporate a combination of some or all of the aspects.

Although the embodiments have been described in detail, it should be understood that various changes, substitutions and alterations can be made herein without departing from the scope as defined by the described embodiments. Moreover, the scope of the present application is not intended to be limited to the particular embodiments of the process, machine, manufacture, composition of matter, means, methods and steps described in the specification.

As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized. Accordingly, the embodiments are intended to include within their scope such processes, machines, manufacture, compositions of matter, means, methods, or steps.

As can be understood, the examples described above and illustrated are intended to be exemplary only.

1. A system for autofill of one or more input fields on a web page, the system comprising:
a processor;
a non-transitory computer-readable media storing instructions that when executed by the processor, cause the system to:
obtain a first data set representative of user data associated with a user device used to access one or more web pages from a web server;
obtain a second data set representative of site data from data communication messages between the user device and the web server;
determine, using a page classifier module, if a current web page from the one or more web pages includes at least one input field for autofill;
when the current web page is determined to include at least one input field for autofill: use a field classifier module to identify one or more input fields for autofill from the at least one input field;
generate, based on one or both of the user data and site data, one or more values for the one or more input fields; and
perform an autofill of the one or more input fields with the one or more values.

2. The system of claim 1, wherein the instructions, when executed by the processor, cause the system to:
initiate a watcher process to periodically or continuously monitor changes in the current web page;
perform an initial autofill of the one or more input fields in the current web page; and
upon detecting a change on the current web page, perform a second autofill of the one or more input fields in the current web page.

3. The system of claim 1, wherein performing an autofill of the one or more input fields with the one or more values comprises:
simulating a user-agent; and
injecting, into an instruction set for loading user interface (UI) elements on an user interface for the current web page, a value from the one or more values, the value generated based on at least one data set from the user data.

4. The system of claim 3, wherein simulating the user-agent comprises:
simulating a sequence of Hypertext Markup Language (HTML) events configured to simulate actions of the user-agent.

5. The system of claim 4, wherein the sequence of HTML events are pre-determined based on a type of input field from the one or more input fields.

6. The system of claim 3, wherein the value comprises part of payment or delivery information.

7. The system of claim 1, wherein the instructions, when executed by the processor, cause the system to:
initiate a listener when a dormant script associated with the current web page indicates that an iframe is loaded as part of the current web page; and
upon detecting, by the listener, that the iframe loaded is related to a checkout or payment process, perform autofill of one or more payment fields in the iframe loaded.

8. The system of claim 2, wherein the watcher process is configured to monitor changes in a Document Object Model (DOM) associated with the current web page.

9. The system of claim 2, wherein the watcher process is configured to monitor changes in one or more selectors in the site data.

10. The system of claim 1, wherein the one or more one or more values used for autofill for the one or more input fields are generated using a machine learning module.

11. A computer-implemented method for autofill of one or more input fields on a web page, the method comprising:
obtaining a first data set representative of user data associated with a user device used to access one or more web pages from a web server;
obtaining a second data set representative of site data from data communication messages between the user device and the web server;
determining, using a page classifier module, if a current web page from the one or more web pages includes at least one input field for autofill;
when the current web page is determined to include at least one input field for autofill: using a field classifier module to identify one or more input fields for autofill from the at least one input field;
generating, based on one or both of the user data and site data, one or more values for the one or more input fields; and
performing an autofill of the one or more input fields with the one or more values.

12. The method of claim 11, comprising:
initiating a watcher process to periodically or continuously monitor changes in the current web page;
performing an initial autofill of the one or more input fields in the current web page; and
upon detecting a change on the current web page, performing a second autofill of the one or more input fields in the current web page.

13. The method of claim 11, wherein performing an autofill of the one or more input fields with the one or more values comprises:
simulating a user-agent; and
injecting, into an instruction set for loading user interface (UI) elements on an user interface for the current web page, a value from the one or more values, the value generated based on at least one data set from the user data.

14. The method of claim 13, wherein simulating the user-agent comprises:
simulating a sequence of Hypertext Markup Language (HTML) events configured to simulate actions of the user-agent.

15. The system of claim 4, wherein the sequence of HTML events are pre-determined based on a type of input field from the one or more input fields.

16. The method of claim 11, comprising:
initiating a listener when a dormant script associated with the current web page indicates that an iframe is loaded as part of the current web page; and
upon detecting, by the listener, that the iframe loaded is related to a checkout or payment process, performing autofill of one or more payment fields in the iframe loaded.

17. The method of claim 12, wherein the watcher process is configured to monitor changes in a Document Object Model (DOM) associated with the current web page.

18. The method of claim 12, wherein the watcher process is configured to monitor changes in one or more selectors in the site data.

19. The method of claim 11, wherein the one or more one or more values used for autofill for the one or more input fields are generated using a machine learning module.

20. A non-transitory computer readable medium storing machine interpretable instructions, when executed by a processor, cause the processor to perform:
obtaining a first data set representative of user data associated with a user device used to access one or more web pages from a web server;
obtaining a second data set representative of site data from data communication messages between the user device and the web server;
determining, using a page classifier module, if a current web page from the one or more web pages includes at least one input field for autofill;
when the current web page is determined to include at least one input field for autofill: using a field classifier module to identify one or more input fields for autofill from the at least one input field;
generating, based on one or both of the user data and site data, one or more values for the one or more input fields; and
performing an autofill of the one or more input fields with the one or more values.
